(19) United States
(12) Patent Application Publication
(10) Pub. No.: US 2004/0183744 A1
(43) Pub. Date: Sep. 23, 2004

(54) Antenna for explosive environments

(76) Inventor: Clifford E. Raiman, Roselle, IL (US)

Correspondence Address: George H. Gerstman, Seyfarth Shaw, Suite 4200, 55 East Monroe Street, Chicago, IL, 60603, US

(21) Appl. No.: 10/439,006

(22) Filed: May 15, 2003

Related U.S. Application Data
(60) Provisional application No. 60/455,514, filed on Mar. 18, 2003.

(51) Int. Cl. H01Q 1/50

(52) U.S. Cl. 343/906

(57) ABSTRACT

An antenna for use in explosive environments. The antenna comprises a mounting base, a non-ferrous radiating element coupled to the mounting base, a radome carried by the mounting base and enclosing the radiating element, and a cable connector carried by the mounting base for coupling a co-axial cable to the antenna.

### RELATED APPLICATION

This application claims the benefit of provisional application Serial No. 60/455,514, filed Mar. 18, 2003, and entitled “Antenna for Explosive Environments.”

### FIELD OF THE INVENTION

The present invention concerns a novel antenna for use in various types of explosive environments.

### BACKGROUND OF THE INVENTION

Explosive environments require that there be nothing that could generate any electrical sparking or arcing. When lighting and other electrical circuits are used in these environments they require specialized conduits, junction boxes and light fixtures using special alloy cast aluminum junctions boxes and special sealant compounds depending on the class and division of protection needed. Some of these special junction boxes also have sealed built in observation windows to observe meters or other read out devices. The glass for these windows is especially formulated and is quite thick, on the order of ½ inch. For all of these items to quality for this use they must pass rigorous testing by agencies such as U.L. and C.S.A. to be approved.

Now in this age of wireless data communications, it has become necessary to develop communication equipment, including antennas to work in these difficult, explosive environments. They would typically relay data such as pressure, temperature and levels etc. To this end, I have developed a very specialized antenna that will operate in this restrictive environment.

### SUMMARY OF THE INVENTION

In accordance with the present invention, an antenna is provided for use in explosive and corrosive environments. The antenna comprises a mounting base; a non-ferrous radiating element coupled to a mounting base; a radome carried by the mounting base and enclosing the radiating element; and a cable connector carried by the mounting base for coupling to a coaxial cable.

In the illustrative embodiment, the radiating element is formed of brass and is centrally positioned with respect to the mounting base. The radome is formed of a molded plastic material that is positioned symmetrically about the radiating element.

In the illustrative embodiment, the mounting base defines a cavity having sealant therewithin. A printed circuit board is coupled to the mounting base, with the printed circuit board carrying an inductor for grounding the radiating element.

A more detailed explanation of the invention is provided in the following description and claims and is illustrated in the accompanying drawings.

### BRIEF DESCRIPTION OF THE FIGURES

FIG. 1 is an elevational view of an antenna constructed in accordance with the principles of the present invention.

FIG. 2 is the bottom view thereof.

FIG. 3 is a cross sectional view of the antenna of FIG. 1.

FIG. 4 is a front view of a circuit board for use with the antenna of FIGS. 1-3.

FIG. 5 is a cross sectional view of the mounting base of the antenna of FIGS. 1-3.

FIG. 6 is an elevational view of the mounting base of FIG. 5.

FIG. 7 is a left side elevational view thereof.

FIG. 8 is a right side elevational view thereof.

FIG. 9 is a front view of the circuit board in the antenna of FIGS. 1-8.

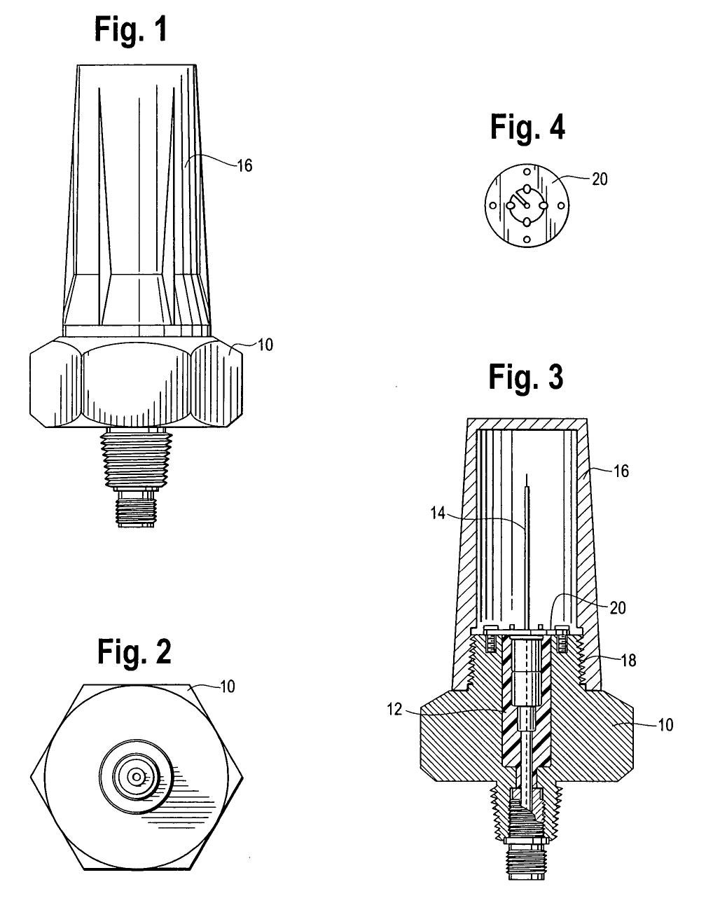

### DESCRIPTION OF THE INVENTION

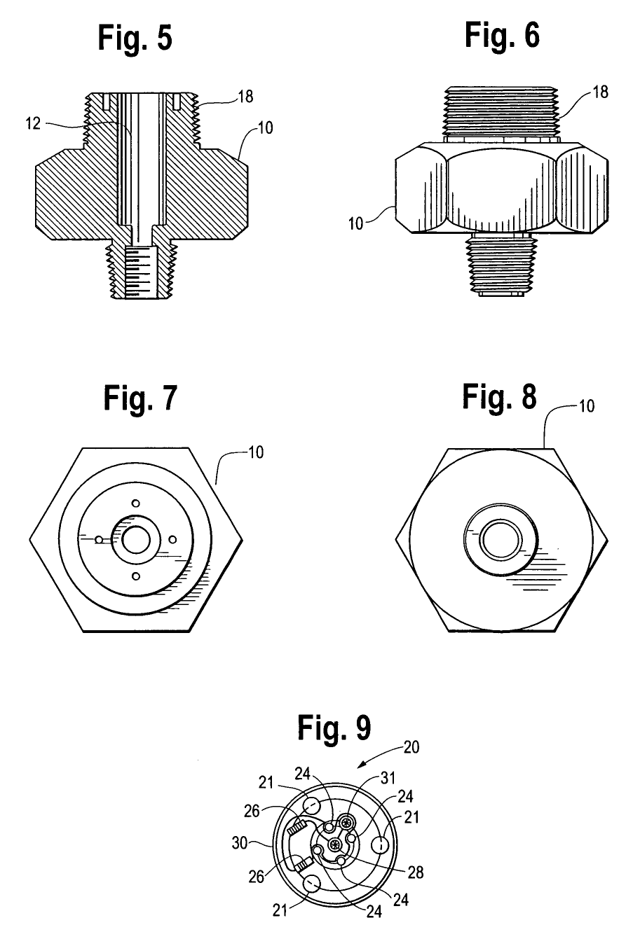

Referring to the Figures, the antenna comprises a mounting base 10 preferably comprising a 2″ inch hex base fitting preferably formed of metal. As illustrated in FIGS. 3 and 5, the mounting base 10 defines a central cavity 12 filled with a sealant material.

A radiating element 14 is formed of a non-ferrous material such as brass. A molded radome 16, preferably formed of ABS plastic, is threadingly sealed to the base 10 by a threaded engagement with threads 18 of base 10. A printed circuit board 20 (FIG. 9) with a surface mounted inductor is positioned within the molded radome 16 over the base 10. The printed circuit board is connected to base fitting 10 by means of suitable screws 22.

As illustrated in FIG. 9, the circuit board 20 is preferably formed of generic FR-4, which is a fiberglass circuit board material with copper on one side. It is 1/16 inch thick, single sided, with plated through holes and it is tin plated. FIG. 9 shows the front of the circuit board 20 having the copper front surface, and defining openings 21 for screws 22 which connect the circuit board to the mounting base 10 and also openings 24 for connector pins that go through the board. A pair of coated inductor coils 26 are positioned on the circuit board 20, and are coupled from the center pin 28 at the center of the board 20 to the outer ring 30 of the copper which is grounded by means of the three mounting screws 22. The radiating element 14 is soldered to the trace 31 of the circuit board 20, which is connected to the center 28 of circuit board 20 where the center pin of circuit board 20 is soldered.

It can be seen that the molded radome acts to seal the radiating element from the environment. Radiating element 14 is D.C. grounded by utilizing inductance 26 on printed circuit board 20, which also supplies the mounting for the antenna element 14. The inductance 26 on circuit board 20 shunts the antenna feed point and effectively D.C. grounds the antenna. The non-ferrous radiating element 14 is completely enclosed by the rugged molded radome 16, which is cemented and screwed onto base fitting 10.

The base fitting 10 has a bulkhead R.F. connector mounted inside a ¾ inch I.P.S. threaded stud which screws into an explosion-proof aluminum junction box. Internally in this base is a cavity that is filled with the sealant. After filling this cavity, the circuit board 20 is then attached to the base 10, which then effectively puts the antenna radiator 14 at equipment ground potential. Thus even if the protective radome were broken off, there would be no hazard.

Although an illustrative embodiment of the invention has been shown and described, it is to be understood that various modifications and substitutions may be made by those skilled in the art without departing from the novel spirit and scope of the present invention.

What is claimed:

1. An antenna for use in explosive and corrosive environments, which comprises:
a mounting base;
a non-ferrous radiating element coupled to said mounting base;
a radome carried by said mounting base and enclosing said radiating element;
a cable connector carried by said mounting base for coupling a coaxial cable to the antenna.

2. An antenna as defined in claim 1, in which said radiating element is formed of brass.

3. An antenna as defined in claim 1, in which said radiating element is centrally positioned with respect to said mounting base and said radome is formed of a molded plastic material that is positioned symmetrically about said radiating element.

4. An antenna as defined in claim 1, in which said mounting base defines a cavity having sealant therewithin.

5. An antenna as defined in claim 1, including a printed circuit board coupled to said mounting base, said printed circuit board carrying an inductor for grounding said radiating element.

6. An antenna as defined in claim 1, including an inductor for grounding said radiating element.

7. An antenna for use in explosive and corrosive environments, which comprises:
a mounting base;
a non-ferrous radiating element coupled to said mounting base;
said mounting base defining a cavity having sealant therewithin;
a radome carried by said mounting base and enclosing said radiating element;
an inductor for grounding said radiating element; and
a cable connector carried by said mounting base for coupling a coaxial cable to the antenna.

8. An antenna as defined in claim 7, including a printed circuit board coupled to said mounting base, said printed circuit carrying said inductor for grounding said radiating element.

9. An antenna as defined in claim 8, in which said radiating element is centrally positioned with respect to said mounting base and said radome is formed of a molded plastic material that is positioned symmetrically about said radiating element.

10. An antenna as defined in claim 7, in which said mounting base includes a threaded stud for coupling to an explosion-proof junction box and said cable connector is mounted inside said threaded stud.
